(19) United States
(12) Patent Application Publication
(10) Pub. No.: US 2024/0174115 A1
(43) Pub. Date: May 30, 2024

(54) SYSTEM AND METHOD FOR CONTROLLED CHARGING OF MULTIPLE ELECTRICAL VEHICLES ON A SINGLE DISTRIBUTION TRANSFORMER

(71) Applicant: Erica SCHMIDT, Coon Rapids, MN (US)

(72) Inventor: Erica SCHMIDT, Coon Rapids, MN (US)

(21) Appl. No.: 18/071,587

(22) Filed: Nov. 29, 2022

(51) Int. Cl. B60L 53/67; H02J 7/00

(52) U.S. Cl. CPC B60L 53/67; H02J 7/00032

(57) ABSTRACT

Electric Vehicles (EV's) are becoming common place and uncontrolled charging eventually will require upgrading existing electrical infrastructure before the end of life of the equipment. By considering the loading on the existing transformer and not charging all vehicles on the transformer at the same time, existing distribution transformers can remain in use for their normal lifespan without degradation. Examining the load involves using data collected from sensors on the transformer and chargers connected to the transformer, and incorporating current limiting functions to maximize charging capability without harming the existing distribution network. The present invention uses a wireless (Wi-Fi, Bluetooth, radio etc.) communicating microcontroller in the distribution transformer to communicate with another wireless communicated device that is talking to the electric vehicle. With the given data, an electrical board that is in the transformer will provide charging direction in terms of time and total current draw. The present invention will enable controlled charging of multiple EV's.

### 1. BACKGROUND INFORMATION

Electric Vehicles (EVs) are fast becoming a common household electric load. However, distribution networks were built assuming a typical house load that has not changed drastically in over 30 years. A single vehicle charging can impact the grid more than adding another house onto the system. Some models use a diversified load of 7 kVA of load per house. EV manufacturers, however, are announcing that their systems can charge at a rate of up to 19 kW. Charging multiple vehicles at this magnitude on a single distribution transformer would cause failure of it as well as the primary cable that feeds the transformer. Limiting the EV charging loading on the transformer will therefore prolong the life of the transformer.

It is important to note that design guide standards for houses before EV's accounted for diversification. This is still a valid consideration for EV's as well. Their load will be diversified as owners are taught the importance of charging their batteries only when necessary, in order to maximize the battery life of their vehicles.

### II. SUMMARY OF THE INVENTION

The present invention addresses how to use a transformer monitoring device as the main driver for utility-controlled EV charging. The preferred embodiment addresses transformer loading, and other applications include primary feeder current loading as well. The present invention extends the life of the existing distribution equipment and help with full life expectancy for the existing components. Such application will help provide utilities with time to plan for upgrading the existing system to account for two plus EVs in every home.

The present invention is designed to use wireless communication, such as Wi-Fi (or Bluetooth), capable microcontroller at the transformer with a temperature and current sensor that will communicate to another wireless connected device either built into the EV charger or an external module that will talk to the EV charger. The EV charger module will determine the current charge state of the vehicle battery and have its desired charge complete time input by the user. The transformer module will then create a schedule with these parameters from all connected EV charger modules to ensure that all vehicles are best able to reach the desired level of charge by the correct time. This controlled loading will keep the transformer within its designed operating range. With minimal inputs and outputs, this simple system can solve a very expensive problem that the distribution electric grid is facing.

It is very clear that an unprecedented load is being added to the aging electric infrastructure and will require careful planning to prevent damage to the distribution system. The use of wireless connected devices on the electric distribution grid allows for careful planning and actions to be taken with the now known transformer loading in real-time.

Historically the United States electric grid has not seen such a substantial change in load in such a short period of time. The public is also not aware of how their actions affect the existing infrastructure as every time someone flips on a light switch the electric grid provides the energy to turn on their lights.

### III. Brief Description of the Drawings

The accompanying drawings, which are incorporated in and constitute a part of this disclosure, illustrate various disclosed embodiments. In the drawings:

FIG. 1 is a block diagram of the system featuring the components necessary to simulate this system.

FIG. 2 shows a simplified electrical wiring schematic showing how each ESP32 will be wired. This only represents one “EV” being plugged in.

FIG. 3 shows a software flow chart that informs how the boards are behaving at different times.

### IV. DETAILED DESCRIPTION

### A. Theory

The proposed system is designed to reduce premature failure of transformer and distribution lines due to overloading. In order to do this, the limitations of the equipment must be known and set as limits in the transformer module. A temperature and current limit are required to protect the transformer. Transformers degrade if they become too hot as the winding insulation begins to break down. A temperature sensor inside the transformer will indicate the temperature rise of the transformer without compromising the sealed oil of the transformer. Operators of the distribution system can log total time of the transformer spent above the acceptable limit. This information will then be used to predict early transformer failures allowing for preventative maintenance to prevent outages.

Another limiting factor is the actual current rating of the transformer windings. For this application, the current sensor is used to observe the primary load on a particular distribution transformer. This enables the entire load on the transformer to be measured and calculate the available charging capacity. The wire that goes from the underground distribution transformer to the house is protected by the circuit breaker in the house. As long as the house service was not upgraded without notifying the electric company there is minimal risk of stressing this wire with the load draw of the house/EV.

Individual transformer data could be aggregated with other transformer currents in the area to monitor total current levels on the primary feeder cable. When adding total currents among transformers in a neighborhood or on a feeder total, feeder loading can be determined and reacted upon as needed. This will provide the utility with real-time feeder loading. These two simple and easy to install sensors will allow control of the system to prevent failures on the primary/transformer side of the distribution network.

The charger module has a few required inputs to communicate with the transformer module. First is the interface with the vehicle charger that identifies when a vehicle is ready to charge and secondly also monitor current state of charge. Last is a schedule input from the user that identifies desired final time and state of charge. This would be entered through a phone application (app) or a web interface with the charger module. Transformer module will use these inputs to determine if and at what rate a vehicle can charge at.

With today's current technology, EV batteries last longer and perform best when they are slightly warmed before use as is seen at the end of a charging cycle. Scheduling a time so that the EV completes its charging cycle right before you must drive with it, leads to better battery performance. This is especially true in colder climates where having a warmer battery to start the commute can lead to an increase in battery performance. This should not affect the United States power grid to have vehicles finish their charging in the morning as typical peak loads on the grid are during the day and evenings.

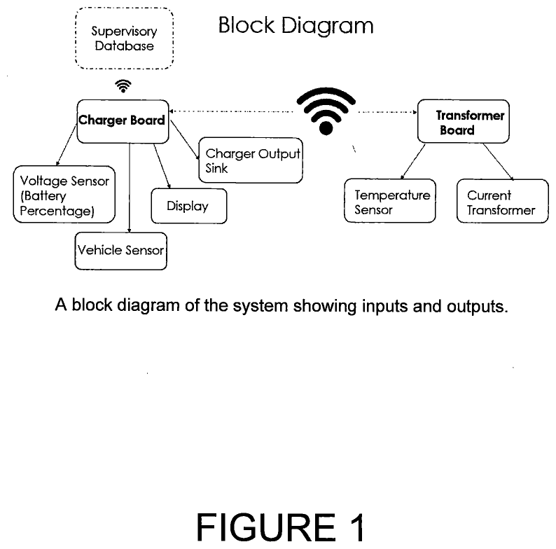

FIG. 1 shows where things are wirelessly communicating as well as where each sensor is located. The charger module would be located at the charger (or it would be the charger in practice) most likely in the garage of the consumer. The transformer board would be inside the pad mount distribution transformer or as an additional box on a pole mount distribution transformer.

Such a system also would allow for the charger to report total kilowatt's consumed (and at what time) to the electric utility, so that the electric utility could implement a specific EV charging rate. This system would be cheaper than maintaining and reading a separate meter as well as having a homeowner provide a separate metered electrical circuit.

### B. Control Methodology

Starting with the charger module, the software has several jobs to manage. First, it needs to allow the vehicle user to input the required completion time and charge level for their vehicle. It would allow the creation of a daily schedule and enable day by day modifications if needed. During charger installation, the size of the charger circuit will need to be configured to determine maximum charger rate. Once connected to a vehicle, it requests state of charge and determines the required amount of time to reach the user's set final charge state. It then communicates this information to the transformer module.

The transformer module aggregates data from all charger modules linked to that distribution transformer and creates a charging schedule that best meets the needs of the customers. If there is a predicted risk of not reaching the desired charge state, users will be notified through a phone app or web interface with their charger.

There are several modes that transformer can request that the charger modules to operate in depending on the number and charge state of the connected vehicles. First, in the case of a single vehicle or vehicle at a state of charge below a required minimum threshold, that vehicle would be charged at its maximum rate. If that rate exceeds the current capacity of the transformer, the charge rate will be reduced until the transformer current is at an acceptable level. If the current is not excessive and another vehicle is connected, then the next vehicle in the priority list will begin charging at the maximum allowable rate. This will continue using the predetermined vehicle charge priority until the transformer is operating at maximum allowable current. Once all vehicles have reached the minimum required charge state, the priority list is reanalyzed. This charging structure is to reduce the possibility of having an electric vehicle with no battery in the case of an emergency.

The next case is two or more vehicles are connected and all are above the minimum required charge state. The transformer module will have all connected vehicles charging at a rate that keeps the transformer current at or below the maximum allowed current. Vehicles with larger batteries or at a lower state of charge will be charged at a higher rate than the other vehicles. This rate will be determined such that all vehicles will be closest to the users desired charge completion.

The final mode would be that the transformer is at or above the allowable current with no vehicles charging. The phone app or web interface would alert the users that the transformer can not support charging vehicles and they should reduce other electrical loads to enable vehicle charging.

### C. Prototype Components

A prototype system was built to develop the control methodology. The prototype utilizes 5 volt microprocessors and charged AA batteries. An AC current transformer was selected that was small enough to detect current on the 5V power supply for the transformer module. To extend this to a 25 kVA underground distribution transformer, a much larger current sensor is needed. Only one current sensor on the primary side of the transformer is needed instead of one on each secondary circuit. When designing for this application, the total temperature in the transformer will need to be accounted for such that the current sensor does not become stressed due to the heat inside the box and lack of airflow.

The temperature sensor used is a TMP37FT9Z. This sensor is good from 5-100 Degrees C. which in Northern climates is not ideal in the winter, but the reasoning for this sensor is to detect when the transformer is being degraded due to being too hot. Therefore, this temperature sensor will work in those situations. Since this particular sensor is small and can easily be made water resistant, it is a good fit for inside a pad mount distribution transformer. These transformers are waterproof and will have space to be able to glue something this small on the inside of the transformer on the wall that holds the transformer oil. This will give the most accurate representation of transformer oil temp without drilling into a sealed environment that could lead to leaking fluids, as this is a major concern with a utility.

A vehicle position sensor is used to wake up the board and also to tell the transformer charging board that there is an EV present that would like to charge. The sensor has a switch and once the battery has been connected to the battery holder, it shows as closed. This tells the charger board that a “vehicle” is present in the system. Previous control modules/radio-controlled meters have locked out vehicles charging due to not having these switches in place and, therefore, not recognizing the system before allowing charging of the EV. This arrangement will allow the system to recognize the vehicle's presence and read its desired charging characteristics before allowing the charging to happen. The system will then be able to review if other vehicles have plugged in and want to charge at the same rates and times. The selected switch is a spring-operated simple switch that would either need to be integrated into the plug or be something that the EV charger is capable of communicating to the board before it attempts to start charging the EV.

For the functionality testing, AA rechargeable batteries may be used for ease of wiring and easy accessibility. To accommodate this in the functionality testing, a charging circuit was developed that includes MOSFETs and resistors. In practice, this would all be included in the EV charger in the vehicle and it would be able to communicate either with a wireless board in the garage that will communicate or directly to the transformer board.

There are many different kinds of EV chargers on the market with a broad range of specifications associated with them. Some of them are a few kW while others are 10-20 kW size. Tesla's 11.5 kW charger uses 48 amps and provides 44 miles of range in one hour in the maximum setting [4]. This setting drops down as circuit breaker amperage goes down as well as by type of vehicle. As shown in the below Table 1.

TABLE 1
[4] Tesla's charging rates and kW consumed by each
type of vehicle at different circuit breakers.

| Wall Connector Technical Details | | | Charge Speed | | | |
|---|---|---|---|---|---|---|
| Circuit | Maximum | Power at | Max miles of range per hour of charge | | | |
| breaker | output | 240 volts | Model S | Model 3* | Model X | Model Y |
| (amps) | (amps) | (kilowatt) | (mph) | (mph) | (mph) | (mph) |
| 60 | 48 | 11.5 kW | 34 | 44 | 30 | 42 |
| 50 | 40 | 9.6 kW | 29 | 37 | 25 | 36 |
| 40 | 32 | 7.7 kW | 23 | 30 | 20 | 29 |
| 30 | 24 | 5.7 kW | 17 | 22 | 14 | 21 |
| 20 | 16 | 3.8 kW | 11 | 15 | 8 | 14 |
| 15 | 12 | 2.8 kW | 7 | 11 | 5 | 10 |

This table highlights the importance of knowing the circuit breaker size in the garage as it is crucial to determining the max charging rate and limiting capabilities that will result in a fully charged EV when it is needed. While this table is only referencing a Tesla charger and vehicle, it would be a similar situation for other manufacturers of EVs with max output currents for each circuit breaker size as well as miles of charge per hour of charging at that rate.

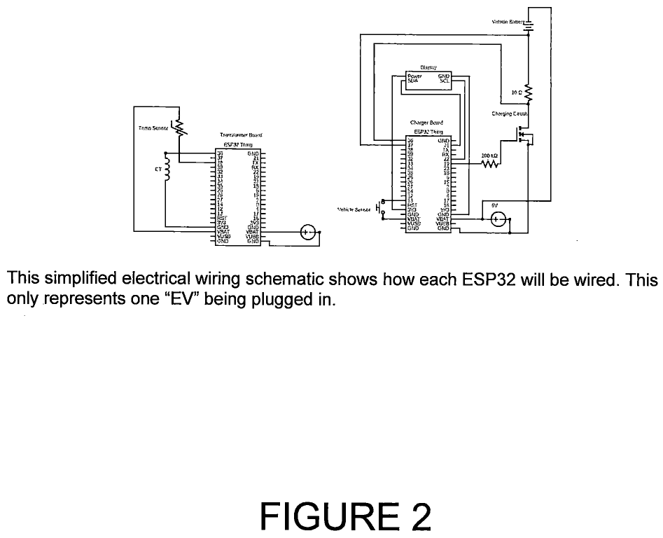

To simulate the present invention, a Sparkfun ESP32 was used. ESP32 is a small microcontroller that has many inputs and outputs that make it suitable for this application. It is small and relatively inexpensive. These are important factors in reducing costs now and allowing for time to replace the necessary equipment after it has aged out of service if possible. Being small is important when placing in a box of an energized system to allow for the best and safest access to the electrical linemen that may need to enter the transformer. The wiring diagram in FIG. 2 shows the I/O and how many are being used in this application. Having open I/O it will allow for growth or future development as well as a redundancy if needed.

### D. Prototype Schematics

As an example, a vehicle may be plugged in by a simple latched switch that is glued onto the battery holder. When a battery is placed in the holder, it shows a closed contact that the software will use to turn on the board that is in the charging circuit. This is modeled by the switch labeled vehicle sensor shown in FIG. 1. In order for the ESP32 to charge the battery, a simple circuit is needed that includes resistors as current sensors and a MOSFET device to control charging current. This simulation used a display to show the battery percentage and charging status. In practice, this would be done on a web interface or as an app on a cell phone.

### E. Prototype Code

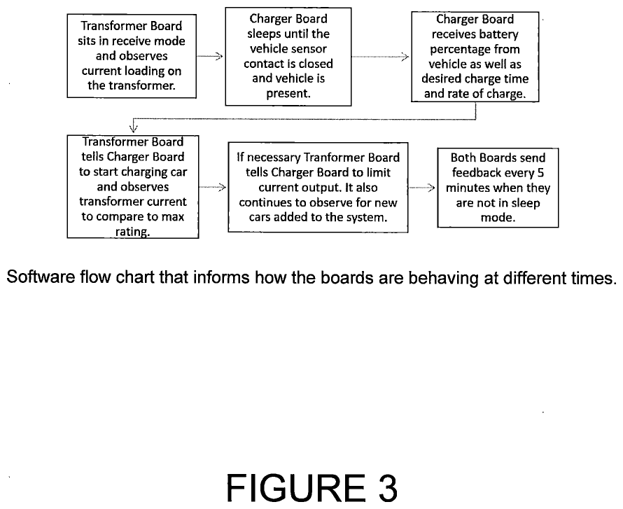

The code for the Sparkfun ESP32 is written in C and follows the following flow chart as shown in FIG. 3. As seen from the first box there are parameters that will need to be set up for the code to reference as needed.

The code will need to start with set inputs for each component. For the transformer board we will need to know the max current output for that transformer as well as overloading limits. General practice for a distribution transformer is to allow it to go above the designed limits for limited periods of time, which allows for this system to react and reduce loading if the transformer gets outside of these limits. The code will need to have design limits and over current setpoints for the transformer. It will also need to have the total primary current rating if it is talking to other transformer boards in the same primary loop. The temperature of the transformer will provide a total rise in oil temperature and is indicative of loading conditions beyond current as transformers at designed full load in very hot weather can be just as detrimental to the transformer as overloaded designed conditions when the transformer is heated too much. This excess heat in the transformer causes the insulation to break down at a much faster rate leading to early failures of the transformer.

The charger board will be required to know the max output of the charger to know the total kilowatts that can be consumed. This will need to be compared to the circuit breaker size as that will limit the current output and thus the total kilowatts that the charger can draw based on the current wire size to the EV charger. A minimum charging percentage will need to be provided so that the vehicles are prioritized based on meeting this minimum charge setpoint to reduce the legal implications of not providing enough energy in an emergency. This application is designed to help with prolonging the battery life of the EV by having the EV charged as close to the desired use time as possible. These batteries work better if they are slightly warm from charging directly before use. Especially in the winter as this will save energy by needing to heat the battery for better use [5].

With this information, the code is set up according to the flow chart in FIG. 3. The charger board will sit in sleep mode until the input changes state for the presence of a plugged-in EV or in this example a rechargeable AA Battery. The transformer board does not have an option to sit in a sleep mode as it has to always be available for accepting data from the EV charger board/s. Once the vehicle present switch has been closed the EV charger board will transmit the charge percentage of the vehicle, the minimum charge setting, and the desired time of use time. The transformer board will take this information and compare it to the other EVs that are charging, if there are any, as well as the current loading on the transformer and the temperature rise of the oil. Using these parameters, the transformer board will tell the EV if it should start charging right away and at what charging rate to allow.

These boards will be communicating with each other every five minutes once a charge rate has been established. This time frame will allow for the battery to charge and show a change in percentage as well as give the boards time for other systems to provide their data. The electric grid system does not have rapid increases or decreases that happen in the span of minutes, so being able to be reactive every couple of minutes is more than enough. As the situation at either the transformer or with other EVs joining the system this would cause output changes that the transformer board will be communicating to the EV charger (Board). Currently the proposed fair option for how to reduce the chargers current draw, is reducing the output of each charger by the same percentage until the transformer is back within its acceptable limits. This system will be recalculating the total percentage that the vehicles are allowed to charge at to reflect the conditions of the transformer.

To take this one step further, if a utility is trying to reduce peak demand during a period that could be programmed into the transformer board as long as it has a way to determine the correct time and will not lose its place In time without needing to be updated. This can either be handled by connecting the transformer boards into a head end that is able to communicate with the transformer boards and read information from them or to have the board's time updated periodically manually. This arrangement prevents charging at the peak time and requires an override by the EV owner to allow charging during this peak. It would come with the caveat that they will either be charged more during this peak time and could overload the transformer resulting in the transformer failing and for power to be out to the entire transformer users until an electric lineman is able to get out with a new transformer to replace it. This information would hopefully reduce people deciding that they must charge during these peak events. These events typically only happen for a few nights a month during the summer months when AC causes a significant load to the grid.

For the long-term analysis of the transformer, it would be helpful for the electric utility to have the total time the transformer spent under conditions that would lead to transformer degradation. Accordingly, the transformer board preferably should be able to store data and have it either communicated back to the utility or be able to be read periodically by getting in the Wi-Fi (Bluetooth, radio) range of the transformer board. The code will need to have a timer set up and add up all the time spent outside of the max limits. The data provided by each transformer board would need to have a unique ID associated with it to make sure the data was property attributed to the correct transformer. This data would then need to be logged and reviewed at the utility to do predictive analysis for transformer failure. It can also be used in the planning department to decide where to allocate the limited resources to prevent loss of power.

### F. System Performance

This present invention prototype is able to correctly limit the output of up to three “EVs” or rechargeable batteries at varying states of charge. The code considers the different charge ratings of the charging circuits as well as the minimum charge percentage for each battery. These characteristics are entered by the owner of the EV so they are responsible for knowing their system to get the desired outcome. It is important to note that this situation is mutually beneficial to have the EV owner take part as well as the utility because many utilities cannot afford to preemptively upsize their transformers as well as the primary wires to each of them. Therefore, the consumers by being part of this process can allow for minimal control of the EV charging and reduce the chances of having an unpredicted outage. In the current market due to the pandemic, there is a shortage of distribution transformers so until this supply issue is fixed upsizing the existing infrastructure that is currently meeting needs is not a priority.

The proposed prototype system is relatively simple to model using rechargeable batteries, switches, and sensors. The Sparkfun ESP32 Thing contains inputs on it that are able to measure the voltage of the battery once it is plugged in as well as easily interface with the other sensors. The placement of these boards will not require batteries, thereby reducing the cost of maintenance and replacement costs. Using both boards in this embodiment of the present invention uses about ten watts of electricity a day. That is roughly equivalent to using an LED light bulb for 1 hour. The current transformer (CT) draws its power directly from the line so it does not have an impact to the total power used and the temperature sensors power consumption is quite small. The power consumption of the devices is listed out in Table 2.

| Sensor/FFD/RFD | Transmit | | Receive | Normal | Sleep | | Measured |
|---|---|---|---|---|---|---|---|
| Transformer Board | 160-260 | mA | 90 mA | 80 mA | 5-10 | mA | 130 mA/12 bytes |
| Charger Board | 160-260 | mA | 90 mA | 80 mA | 0.15 | mA | 130 mA/12 bytes |

| | | | | | | |
|---|---|---|---|---|---|---|
| Display - Charger Board | N/A | N/A | 50 mA | 0 | mA | 49 mA |

| Voltage Sensor | On Board | | N/A | N/A | N/A | N/A |
|---|---|---|---|---|---|---|
| Vehicle Sensor | N/A | | N/A | N/A | N/A | N/A |
| Current Sensor | N/A | | N/A | N/A | N/A | N/A |
| Temperature Sensor | 10 | mA | N/A | 10 mA | N/A | N/A |

### G. Additional Considerations

The present invention shows with a CT and a temperature sensor, preventable distribution transformer failures are minimized. In other applications the system may not have a “charger board” and would instead communicate directly with the EV charger. This will require secure interfacing with many different manufacturers of chargers with possibly different networking protocols. Cyber security is extremely important when it comes to operating with utilities and this will pose a significate importance to how to be able to integrate with the EV chargers.

Ideally the information on transformer loading would eventually report back to the utilities' SCADA system or other information management system. With all incoming data it would require that the utility aggregate the data and track which areas are requiring upgraded feeder cables and transformers the most. Ideally with a timer set up, transformer time spent at too high of a temperature could be tracked and lead to a scheduled replacement of the transformer before it completely fails. This would reduce costs of on-call crews going out to do this work after hours. It would also reduce the need for emergency locates and allow for planning and purchasing to get parts ordered in preparation for upcoming work.

If this system was able to reflect and track total power consumed by the EV in comparison to the rest of the house load and store the information, it could lead to EV charging rates. Thus without having to install a second meter the system could track total energy consumed by the EV and bill it at a different rate if that was desired. By using this system to track energy consumed by a certain circuit in the house it saves the cost of installing and maintaining the meter as well as electrician work on behalf of the homeowner to get a separately metered circuit in their electrical panel.

### V. Conclusion

In accordance with the present invention, controlling the EV charging rate will prevent overloading the existing transformer. Taking into account all of the parameters that are crucial to load balance, the system and method of the present invention may greatly impact large underground distribution networks. For overhead applications a pole mounted box to house the transformer board and weather proof CT's will be necessary. Loads will have to be monitored by the electric company to make sure that transformers are upgraded once this system can no longer maintain correct charging of EV's and electric consumers demands are not being met that will drive the need for upgraded equipment. By using a wireless sensor network the cost of installation is greatly reduced as no additional wires need to be ran and allows for quick install and changes to the system to adjust for added EV's onto the transformer. This application will be necessary to bridge the gap of adding the huge electric load of added EV's onto aging infrastructure. This application will need to consider wireless security and integration with multiple brands of chargers as well as an application for how to integrate with the system. With all consumer products this application must be simple and easy to use so that there is an ease of compliance. All of this work is dependent on people being willing to sign up for a load monitoring system and have their charger outputs be limited for the benefit of the current electrical grid.

What is claimed is:

1. A system providing for controlled charging of multiple electric vehicles on a single distribution transformer to prevent overloading the existing power grid, the system comprising:
a distribution transformer;
a wireless controller communicating with the electric vehicles; and
a second wireless controller in the distribution transformer,
wherein the distribution transformer is adapted to optimize the charging direction in terms of time and total draw, thereby controlling the charging of multiple electrical vehicles simultaneously and limiting the load on the distribution transformer.

2. The system as defined in claim 1, wherein the system includes a temperature sensor connected to the distribution transformer.

3. The system as defined in claim 1, wherein the system includes a current sensor to assess current load on the distribution transformer.

4. The system as defined in claim 1, wherein the system includes means for aggregating distribution transformer current levels near the distribution transformer for modulating the load and setting a controllable limit on transformer output.

5. The system as defined in claim 1, wherein the system includes a charger for collecting kilowatt consumption and means for reporting kilowatt consumption.

6. A system providing for monitoring controlled charging of multiple electrical vehicles in a regional area, comprising:
means for aggregating transformer current levels; and
means for receiving and modulating charging levels based on regional current levels.
